(19) United States
(12) Patent Application Publication
(10) Pub. No.: US 2009/0294719 A1
(43) Pub. Date: Dec. 3, 2009

(54) VALVE FOR A COMPRESSED GAS CONTAINER

(75) Inventors: Eric Jeske, Todesfelde (DE); Michael Horn, Oldendorf (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: LINDAL Dispenser GmbH, Schonberg (DE)

(21) Appl. No.: 12/398,360

(22) Filed: Mar. 5, 2009

(30) Foreign Application Priority Data
May 30, 2008 (DE) 10 2008 026 322.2

(51) Int. Cl. F16K 1/00

(52) U.S. Cl. 251/333

(57) ABSTRACT

A valve for a compressed gas container, with a longitudinal valve housing, which is held in a valve disc at one end and surrounds a channel for the medium which is to be discharged, a valve member, which is partly arranged in the channel of the valve housing and projects from the valve housing at the held end thereof, a sealing element, which sealingly encloses the valve member and whose position on the valve housing is fixed, wherein the valve member features an outlet channel, which can be brought into connection with the channel of the valve housing via at least one cross bore, wherein the outlet channel features a bore on its bottom, via which the outlet channel of the valve member is in connection with the channel of the valve housing, wherein the bore is closed by a spring prestressed valve body, which is lifted from the bore against the spring force upon a predetermined pressure in the channel of the valve housing and unblocks a direct connection between the channel of the valve housing and the outlet channel of the valve member.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a valve for a compressed gas container. A compressed gas container is a container whose content is under pressure and is discharged by actuation of the valve. When it is dealt with the production of aerosols, the container can in principle also be regarded as an aerosol container. When the compressed gas container is used for gaseous working fluids, where it does not depend on the mixture of the working fluid with air, one speaks occasionally also of a compressed gas package.

From WO 2007/104327 A1, the entire contents of which is incorporated herein by reference, a delivery device for a flowable medium is known, as well as a dispenser apparatus with such a delivery device. The delivery device features a valve device, which is arranged downstream in the product delivery channel. The valve arrangement is formed as a pressure relief valve, which opens from on a certain overpressure in the interior of the container and permits unintended discharge of the medium. The pressure relief valve is formed as a diaphragm valve, which is provided with a cross recess and opens itself automatically towards the outside for the discharge of a medium from on a preset pressure drop inside the product discharge channel.

From EP 0 786 289 B1, the entire contents of which is incorporated herein by reference, an admission pressure pump vaporiser is known, which has a secondary piston in the valve member, wherein the secondary piston is pressed out of its sealing position when the pressure in the container is too high, in order to unblock a product discharge channel.

From G 91 11 5351.2, the entire contents of which is incorporated herein by reference, a valve for compressed gas is known, in which the valve member has a cross bore which is closed by an overpressure device. A series of approaches are known for the overpressure device. For instance, it is proposed to close the cross bore by a sealing element element which is gued in and which unblocks the cross bore at too high an overpressure. Alternatively, it is also proposed to provide a spring prestressed stopper or a thick disc in order to close the cross bore.

The present invention is based on the objective to provide a valve for a compressed gas container, which permits an overpressure compensation of the interior space of the container with means which are as simple as possible, and which is suited for very large pressures moreover.

### BRIEF SUMMARY OF THE INVENTION

The valve of the present invention is envisioned for a container, whose gas charge is under pressure. The valve has a longitudinal valve housing, a valve member and a sealing element. The longitudinal valve housing is held in a valve disc at one end and surrounds a channel for the medium which is to be discharged. The valve member is partly arranged in the channel of the valve housing and projects from the valve housing at that end thereof which is held. The valve is actuated via the valve member, wherein a spraying actuator or another spraying device can be set up on the valve member, for instance. Further, the valve of the present invention has a sealing element, which sealingly encloses the valve member and whose position on the valve housing is fixed. The valve member has an outlet channel, which can be brought into correction with the channel of the valve housing via at least one cross bore. In order to discharge the medium of the compressed gas container, the valve member is set into a position such that it is not closed by the sealing element, and the interior space of the container is in communication with the outlet channel of the valve member via the channel in the valve housing. In the valve of the present invention, the outlet channel of the valve member is additionally provided with a bore at its bottom, through which the outlet channel of the valve member is in communication with the channel of the valve housing. The bore is closed by a spring prestressed valve body, which is moved out of the bore against the spring force upon a predetermined pressure in the channel of the valve housing, and unblocks a direct connection between the channel of the valve housing and the outlet channel of the valve member. In the solution of the present invention, the valve member is provided with an additional bore. This means that independently of the actuation of the valve member, the spring prestressed valve body is arranged in the same. In a regular actuation of the valve member, the valve body closing the bore remains in its sealing position. Through this emerges the advantage that the overpressure, upon which the valve body is removed from the bore, can be selected independently from the otherwise present pressure at the actuation of the valve. It is added in the valve of the present invention that an overpressure occurring for a short time opens the compressed gas container only for a short time. As soon as the overpressure is no more sufficient to remove the valve body from the bore, the valve member is closed by the valve body again and can be actuated regularly again.

In a preferred embodiment of the valve of the present invention, a ball is provided as the valve body. Also preferably, the bore in the outlet channel features a valve seat for the valve body.

In a preferred embodiment, the valve member is provided with a chamber in the outlet channel at its end pointing away from the valve disc, in which the valve body and the spring thereof are arranged. By providing a chamber at one end of the valve member, which accommodates the valve body and the spring thereof, the regularly used outlet channel can be dimensioned independently from the dimensions of the chamber. Thus, the design of the outlet channel is not limited by the dimensions of the chamber.

In a preferred embodiment, the outlet channel is provided with a mouth section at its end pointing away from the valve disc, which is delimited by a circumferential wall of the valve member. The mouth section may be formed cylindrical or conical, wherein the mouth section has a diameter which is greater than twice the wall thickness of the valve member.

In a preferred embodiment, the chamber in the outlet channel is connected to the mouth section via at least one connection channel. By the separation of the flow paths for the medium in the regular use and in the case of overpressure, both outlet paths can be dimensioned independently from each other. By the at least one connection channel, both areas are connected with each other. In a preferred embodiment, the diameter of the at least one connection channel is smaller than the diameter of the mouth section.

The valve member is purposefully arranged in the valve housing in its spring prestressed position, such that the cross bore is closed by the sealing element or projects out of the valve body. In the position of the valve member shifted against the spring force, the same is arranged in the valve housing such that the cross bore is in communication with the channel of the valve housing. In the regular actuation of the valve member, the same is axially displaced into the valve housing, wherein the valve body arranged completely inside the valve member and the spring thereof are moved along without that the same open themselves.

In a preferred embodiment, the spring acting upon the valve member is arranged in the valve member and acts upon that end of the valve member which points away from the valve disc.

The channel in the valve housing has preferably a shoulder, which delimits a displacement of the valve member into the valve housing. Thus, it can be made sure that the valve member is not shifted too far into the valve housing. Further, the valve member is provided with projections which bear against the sealing element in the advanced position of the valve member.

The sealing element is preferably formed as a ring, which features a circumferential ring body and a circumferential sealing lip, which bears against the valve member. The sealing element sits in a circular recess of the valve housing, which is delimited by the valve disc, wherein the sealing element is purposefully clamped in between valve disc and valve housing.

The valve member features purposefully a body, which is closed by a termination element at its end pointing away from the valve disc, wherein the termination element features the bore which is closed by the spring prestressed valve body.

### BRIEF DESCRIPTION OF THE SEVERAL FIGURES OF THE DRAWINGS

A preferred embodiment of the valve according to the present invention is explained in more detail by means of the figures in the following.

FIG. 1 shows the valve of the present invention at closed pressure relief valve,

FIG. 2 shows a magnified detail view of the pressure relief valve,

FIG. 3 shows the valve of the present invention at opened pressure relief valve,

FIG. 4 shows a detail view of the pressure relief valve.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

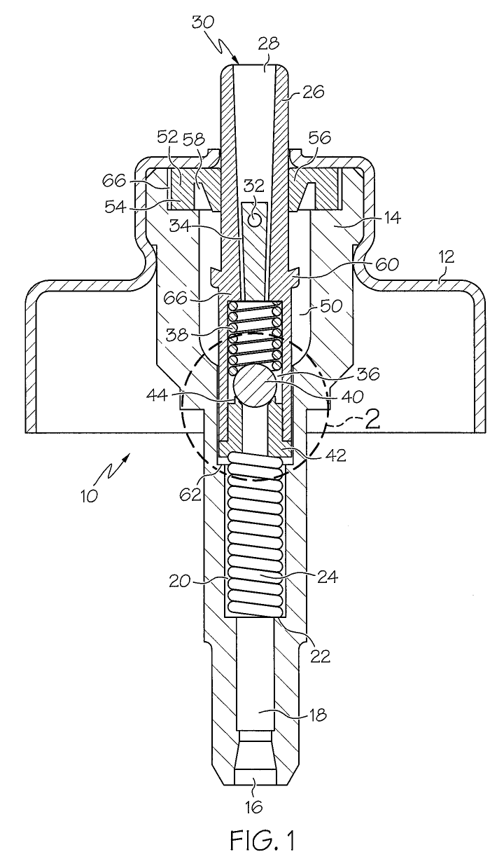

FIG. 1 shows the valve 10 of the present invention in a section view. The valve has a dome-shaped valve disc 12, in which the valve housing 14 is held by a compression moulded deformation. The valve housing 14 has a longitudinal form, which projects into the (not shown) container. The valve housing has an inlet opening 16 for the medium to be discharged at its end pointing away from the valve disc 12. The medium to be discharged may be a gas or a liquid. For instance, the valve of the present invention can be used for a compressed gas container in which liquid carbon dioxide is stored. The particular property of carbon dioxide is that the same can adopt a pressure of 50 bars already at room temperature, so that a pressure compensation is necessary for the pressure container.

The inlet opening 16 is followed by a channel 18, which extends through the entire valve housing and has a chamber 20 downstream of the medium which is to be discharged. On its upstream situated bottom, the chamber has a step 22, on which a spring 24 is supported.

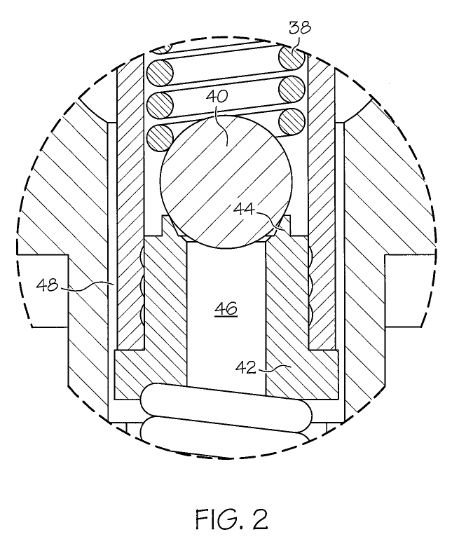

A valve member 26 is arranged in the valve housing 14, which features a mouth section 28. The mouth section 28 enlarges conically towards its outlet opening 30 in the depicted realisation example. The valve member consists of a longitudinal body 66, which forms the outlet channel, with a lock element 42. Below the mouth section 28, the valve member 26 has a cross bore 32, through which the medium to be discharged enters into the valve member. Upstream from the mouth section 28, two connection channels 34 are depicted in the shown example, which connect the mouth section with a chamber 36. In the chamber 36 of the valve member is provided a spring 38, and a ball 40 serving as a valve body. By the spring 38, the ball 40 is pressed onto the valve seat 44, which is formed by a termination element 42 (compare FIG. 2). The termination element 42 is lockingly set into the body 66 of the valve member 26 at the upstream end thereof. The termination element 42 has a bore 46, which connects the chamber 36 of the valve member with the chamber 20 of the valve housing.

The chamber 20 in the valve housing 14 is in communication with an outlet chamber 50 via a ring gap 48 (compare FIG. 2). The downstream end of the outlet chamber 50 is closed by a sealing element 52, which is arranged in a recess 64 of the valve housing 14 and is held in the same by the valve disc 12. The sealing element 52 has a ring body 54, which passes over into a sealing lip 56. Between sealing lip 56 and ring body 54, there is a circumferential deepening 58, which permits an elastic deformation of the sealing lip 56 in the radial direction. In the valve housing 14, outlet chamber 50, ring gap 48 and chamber 20 are constituents of the channel 18. Also, in the valve member, bore 46, chamber 36, connection channel 34 and mouth section 28 are constituents of the channel which extends through the valve member.

In FIG. 1, the valve of the present invention is depicted in its regularly opened position. In the opened position, the cross bore 32 is not sealed up by the sealing lip 56, but is situated in the outlet chamber 50. The outlet chamber 50 is provided with medium via the ring gap 48, the chamber 20 and the outlet channel 18. In order to set the valve into the position shown in FIG. 1, the valve member 26 is pressed into the valve housing 14 against the force of the spring 24. The movement of the valve member 26 in the valve housing is delimited by the shoulder 62 in the valve housing. The shoulder 62 is situated at the upstream end of the chamber 20. Through this, the cross bore 32 moves towards the inside in the valve member and is released from the sealing lip 56. By-passing the valve member via the outlet channel 18 and the chamber 20, the medium under pressure enters into the mouth section 28 through the cross bore 32.

The valve member 26 can be pressed into the valve housing by an actuator or the like, in order to let the medium escape in this way.

In its closed position, thus in its advanced position, the valve member 26 is advanced so far until the projections 60 provided on the outer side of the valve member hit the lower edge of the sealing lip 56. In this position, the cross bore is either still in the area of the sealing lip 56 and is sealed up by the same, or the cross bore is moved beyond the same and out of the valve housing. The deepening 58 on the sealing element 52 additionally supports the sealing rest position of the sealing lip 56 on the outer wall of the valve member 26. The medium being under pressure in chamber 50 enters also into the deepening 58 of the sealing element 52 and presses the sealing lip 56 against the valve member 26.

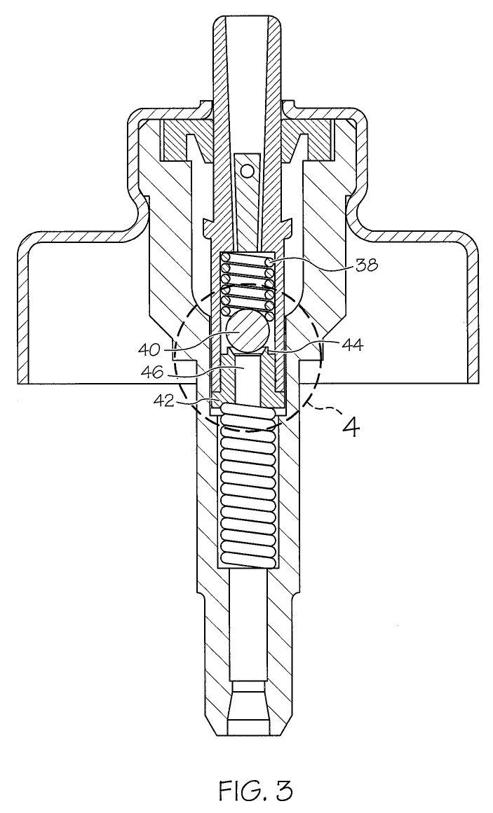

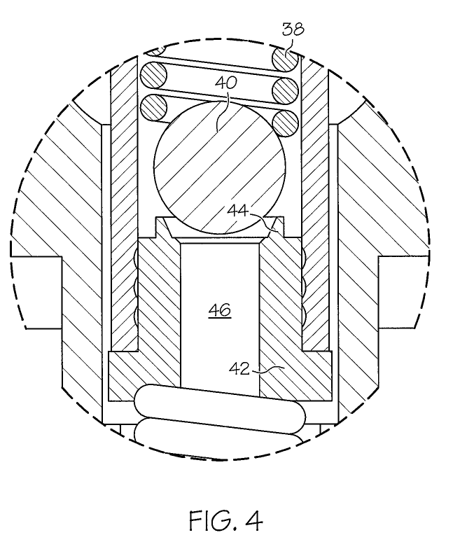

When the pressure in the interior space of the container increases beyond a predetermined value, the medium presses against the valve body 40 through the bore 46 in the termination element 42. As depicted in FIGS. 3 and 4, the valve body 40 is lifted from its valve seat 44 against the force of the spring 38. By-passing the valve body, the medium enters into the chamber 36 of the valve member, and via the connection channels 34 into the mouth section 28, in order to escape via the outlet channel 30. The escape of the medium takes place for so long as the overpressure in the bore 46, and with this in the interior space of the container, is sufficiently high to lift the valve body 40 out of its sealing seat 44. A particular advantage of the valve of the present invention is that the medium is centrally guided through the valve member when an overpressure occurs, so that upon overpressure, the pressure in the outlet chamber 50 and on the sealing element 52 in particular is less than at the inlet opening 16. Thus, it is possible to dimension the outlet chamber 50 and the sealing element 52 for a certain pressure and to make sure, via the spring 38 together with the valve body 40, that a higher pressure can escape already upstream of the chamber 50. The use of two different escape paths for the medium upon overpressure and in the normal operation permits to select the overpressure at which the valve opens relatively freely.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A valve (10) for a compressed gas container, with a longitudinal valve housing (14), which is held in a valve disc (12) at one end and surrounds a channel (18) for the medium which is to be discharged, a valve member (26), which is partly arranged in the channel (50, 48, 18) of the valve housing (14) and projects from the valve housing (14) at the held end thereof, a sealing element (52), which sealingly encloses the valve member (26) and whose position on the valve housing (14) is fixed, wherein the valve member (26) features an outlet channel (28, 34, 36), which can be brought into connection with the channel (50, 48, 18) of the valve housing (14) via at least one cross bore (32), characterised in that the outlet channel (28, 34, 36) features a bore (46) on its bottom, via which the outlet channel of the valve member (26) is in connection with the channel (18) of the valve housing (14), wherein the bore (46) is closed by a spring prestressed valve body (40), which is lifted from the bore against the spring force (38) upon a predetermined pressure in the channel of the valve housing and unblocks a direct connection between the channel of the valve housing and the outlet channel (28) of the valve member.

2. A valve according to claim 1, characterised in that a ball is provided as the valve body (40).

3. A valve according to claim 1, characterised in that the bore (46) in the outlet channel forms a valve seat (44) for the valve body.

4. A valve according to claim 1, characterised in that the valve member (26) features a chamber (36) in the outlet channel at its end pointing away from the valve disc (12), in which the valve body (40) and the spring (38) thereof are arranged.

5. A valve according to claim 1, characterised in that the outlet channel has a mouth section (28) at its end pointing away from the valve disc, which is delimited by a circumferential wall of the valve member (26).

6. A valve according to claim 4, characterised in that the chamber (36) in the outlet channel is connected to the mouth section (28) via at least one connection channel (34).

7. A valve according to claim 6, characterised in that the diameter of the at least one connection channel (34) is smaller than the diameter of the mouth section (28).

8. A valve according to claim 1, characterised in that the valve member (26) is arranged in the valve housing in its spring prestressed position such that the cross bore (32) is closed by the sealing element (52), or that the cross bore (36) projects out of the valve body (14).

9. A valve according to claim 8, characterised in that the valve member (26) shifted against the spring force (24) is arranged in the valve housing (14) such that the cross bore (32) is in communication with the channel (50) of the valve housing.

10. A valve according to claim 9, characterised in that the spring (24) acting upon the valve member (26) is arranged in the valve member and acts upon that end of the valve member which points away from the valve disc (12).

11. A valve according to claim 1, characterised in that the channel in the valve housing features a shoulder (62), which delimits a displacement of the valve member into the valve housing.

12. A valve according to claim 1, characterised in that the sealing element (52) is formed as a ring, which features a circumferential ring body (54) and a circumferential sealing lip (56), which bears against the valve member (26).

13. A valve according to claim 1, characterised in that the sealing element sits in a circular recess (64) of the valve housing (14) which is delimited by the valve disc (12).

14. A valve according to claim 1, characterised in that the valve member features a body (66) which is closed by a termination element (42) at its end pointing away from the valve disc (12), wherein the termination element features the bore (46) which is closed by the spring prestressed valve body (40).
